(19) United States
(12) Patent Application Publication
(10) Pub. No.: US 2026/0055801 A1
(43) Pub. Date: Feb. 26, 2026

(54) Continuously Variable Transmission For Off-Road Vehicle

(71) Applicants: Luzhou Rongda Intelligent Transmission Co., Ltd., Luzhou (CN); Zhejiang CFMOTO Power Co., Ltd, Hangzhou (CN)

(72) Inventors: Kuiyun Wan, Chongqing (CN); Jinping Zhang, Luzhou (CN); Xiaogui Xiao, Luzhou (CN); Guowei Zhang, Luzhou (CN)

(21) Appl. No.: 19/373,058

(22) Filed: Oct. 29, 2025

Related U.S. Application Data
(63) Continuation of application No. PCT/CN2023/098985, filed on Jun. 7, 2023.

(30) Foreign Application Priority Data
May 5, 2023 (CN) 202310494398.8

(51) Int. Cl. F16H 37/02; B60K 17/02; B60K 17/344; F16H 37/06; F16H 57/04; F16H 63/04; F16H 63/32; F16H 63/34

(52) U.S. Cl. CPC F16H 37/021; B60K 17/02; B60K 17/344; F16H 37/065; F16H 57/0436; F16H 63/04; F16H 63/32; F16H 63/3425

(57) ABSTRACT

A continuously variable automatic transmission for an off-road vehicle includes a power input stage, a CVT, a clutch, a forward and reverse gear assembly, and a power output stage connected in sequence. A shift mechanism connected to the forward and reverse gear assembly includes a shift drum, a shift fork, a shifting driving gear sleeve, a spring bias plate seat and a spring-with-two-moving-ends. The shift drum has a shifting track controlling the shift fork and a biasing track controlling the spring bias plate seat. An aggregate sideways force on the shift fork in an axial direction, which includes the force from the spring-with-two-moving-ends, can be controlled at least in part by relative spacing between the shifting track and the biasing track as a function of rotation of the shift drum.

### RELATED APPLICATION INFORMATION

The present application is a continuation of App. No. PCT/CN2023/098985, filed on Jun. 7, 2023, entitled “CONTINUOUSLY VARIABLE TRANSMISSION FOR OFF-ROAD VEHICLE AND OPERATION METHOD THEREOF”, and claims the benefit of priority to Chinese Patent Application Serial No. 202310494398.8, filed on May 5, 2023, entitled “CONTINUOUSLY VARIABLE TRANSMISSION FOR OFF-ROAD VEHICLE AND OPERATION METHOD THEREOF”, the contents of which are hereby fully incorporated by reference into the present application.

### FIELD

The subject matter herein generally relates to the field of continuously variable transmissions, and more particularly, to a continuously variable automatic transmission for an off-road vehicle and an operation method.

### BACKGROUND

Continuously variable transmissions (“CVTs”) are well known for use in off-road vehicles. The continuously variable transmission has advantages of simple driving operation, good smoothness, and low cost. At present in many CVTs, the speed ratio cannot be precisely controlled, and/or can only be passively controlled. The transmitted power is limited and cannot meet the requirements desired for high-performance off-road vehicles. Especially for a turbocharged engine that has a large output torque, rubber CVT belts have difficulty withstanding the large torque transmitted, and rubber CVT belts are vulnerable parts that need to be frequently replaced, resulting in inconvenience and additional cost. Transmission efficiency and reliability of existing CVTs are low. Moreover, oil circuits of existing CVTs are often complex, and planetary gear structures and multiple clutches in associated gearboxes result in complex control methods. Better transmission structures are needed.

### SUMMARY

The present invention is a continuously variable automatic transmission for an off-road vehicle, including a power input stage, a CVT, a clutch, a forward and reverse gear assembly, and a power output stage connected in sequence, and further including a shift mechanism connected to the forward and reverse gear assembly. The power input stage receives torque from the engine of the off-road vehicle, optionally providing a gear reduction. The pulley stage has a primary pulley assembly driven by the power input stage and a secondary pulley assembly, with a belt or chain transferring torque from the primary pulley assembly to the secondary pulley assembly. Effective diameters of the primary pulley assembly and the secondary pulley assembly where they contact the belt or chain are variable. The shift mechanism includes a shift drum, a shift fork, a shifting driving gear sleeve, a spring bias plate seat and a spring-with-two-moving-ends. The shift drum has a shifting track and a biasing track and is rotatable between at least positions for a reverse gear R, a neutral gear N, and a forward gear D. The shift fork is controlled by the shifting track, and the spring bias plate seat is controlled by the biasing track. The shifting driving gear sleeve is coupled to the shift fork and is able to carry torque in the forward and reverse gear assembly. The shape of the shifting track controlling the shift fork to move the shifting driving gear sleeve axially between a reverse gear station, a forward gear station and a neutral gear station between the reverse gear station and the forward gear station. The spring-with-two-moving-ends biases the shift fork relative to the spring bias plate seat, such that an aggregate sideways force on the shift fork in an axial direction can be controlled at least in part by relative spacing between the shifting track and the biasing track as a function of rotation of the shift drum. The output stage is coupled to the forward and reverse gear assembly and receives torque transmitted through the shifting driving gear sleeve. The output stage having a front output for providing torque to a pair of front wheels and a rear output for providing torque to a pair of rear wheels.

### BRIEF DESCRIPTION OF THE DRAWINGS

With reference to the attached figures, the features and the advantages of the present disclosure will be more clearly understood. The figures are illustrative and should not be construed as limiting the present disclosure. In the attached figures:

FIG. 1 is a side view schematically showing a power train using a continuously variable automatic transmission according to a preferred embodiment of the present invention, and schematically showing the surrounding environment of the off-road vehicle in dashed lines;

FIG. 2 is a left side view of the continuously variable automatic transmission schematically shown in FIG. 1;

FIG. 3 is a right side view of the continuously variable automatic transmission of FIGS. 1 and 2;

FIG. 4 is front view of the continuously variable automatic transmission of FIGS. 1-3;

FIG. 5 is a top view of the continuously variable automatic transmission of FIGS. 1-4;

FIG. 6 is a bottom view of the continuously variable automatic transmission of FIGS. 1-5;

FIG. 7 is a front left perspective view of the internal components of the continuously variable automatic transmission of FIGS. 1-6;

FIG. 8 is a cross-sectional view of the continuously variable automatic transmission of FIGS. 1-7, with the cut-line adjusted to intersect through axes of several shafts;

FIG. 9 is a schematic diagram of the continuously variable automatic transmission of FIGS. 1-8;

FIG. 10 is a perspective view of the shift mechanism used in the continuously variable automatic transmission of FIGS. 1-9;

FIG. 11 is a cross-sectional view of the shift mechanism of FIG. 10 in the housing of FIGS. 2-6, with the cut-line adjusted to intersect through axes of the depicted rods and shafts;

FIG. 12 is an exploded perspective view of several of the components of the shift mechanism of FIGS. 10 and 11; and

FIG. 13 is another exploded perspective view of several of the components of FIG. 12, with the shift drum at a different rotational position.

In the figures, reference numerals are: power train 10, off-road vehicle 12, front hood 14, cab 16, door 18, side window 20, rear cargo space 22, seat 24, steering wheel 26, engine 28, front wheels 30, rear wheels 32, front drive shaft 34, rear drive shaft 36, transmission 38, torsional vibration damper 40, CVT 42, gearbox 44, front differential 46, front half shafts 48, rear differential 50, rear half shafts 52, gear selector 54, dashboard 56, shift cable 58, transmission housing 60, power input stage 62, pulley stage 64, clutch 66, forward and reverse gear assembly 68, shift mechanism 70, power output stage 72, electronic control system 74, oil cylinder 76, lubrication oil circuit 78, side teeth 80, shifting fork positioning pin 82, shifting track 84, tines 86, peripheral groove 88, indentations 90, positioning pin 92, and biasing track 94.

The individual internal components of the CVT 42 and gearbox 44 have reference numerals of: CVT input shaft S1, primary pulley shaft S2, secondary pulley shaft S3, driven gear shaft S4, auxiliary shaft S5, intermediate shaft S6, rear driven shaft S7, front driving shaft S8, front driven shaft S9, reverse shaft S10, primary pulley assembly P1, metal belt or metal chain P2, secondary pulley assembly P3, clutch hub C1, outer friction plate C2, inner friction plate C3, clutch output disc C4, input-stage driving gear G1, input-stage driven gear G2, forward driving gear G3, forward driven gear G4, reverse driving gear G5, reverse bridge gear G6, reverse driven gear G7, auxiliary shaft output gear G8, intermediate gear G9, rear driving gear G10, rear driven gear G11, front driving gear G12, front driven gear G13, oil pump driving gear G14, oil pump driven gear G15, shifting driving gear sleeve H1, parking gear H2, compression-spring-with-two-moving-ends H3, spring bias plate seat H4, fork rod H5, brake pawl H6, parking drive sleeve positioning pin H7, parking torsion spring H8, parking drive sleeve H9, parking cam H10, fan-shaped toothed gear H11, shifting driven gear H12, shifting lever H13, shifting drum H14, positioning star-shaped wheel H15, spherical contact H16, gear position sensor H17, star-shaped wheel pin positioning H18, shifting fork H19, compression-spring-with-one-fixed-end H20, retainer plate H21, oil pump Y1, hydraulic valve block F1, needle bearing B1, and needle bearing B2.

### DETAILED DESCRIPTION

Implementations of the present technology will now be described, by way of a preferred embodiment, with reference to the attached figures and embodiments. The embodiment shown and the various embodiments described are used to illustrate the present invention, but not to limit the scope of the present invention.

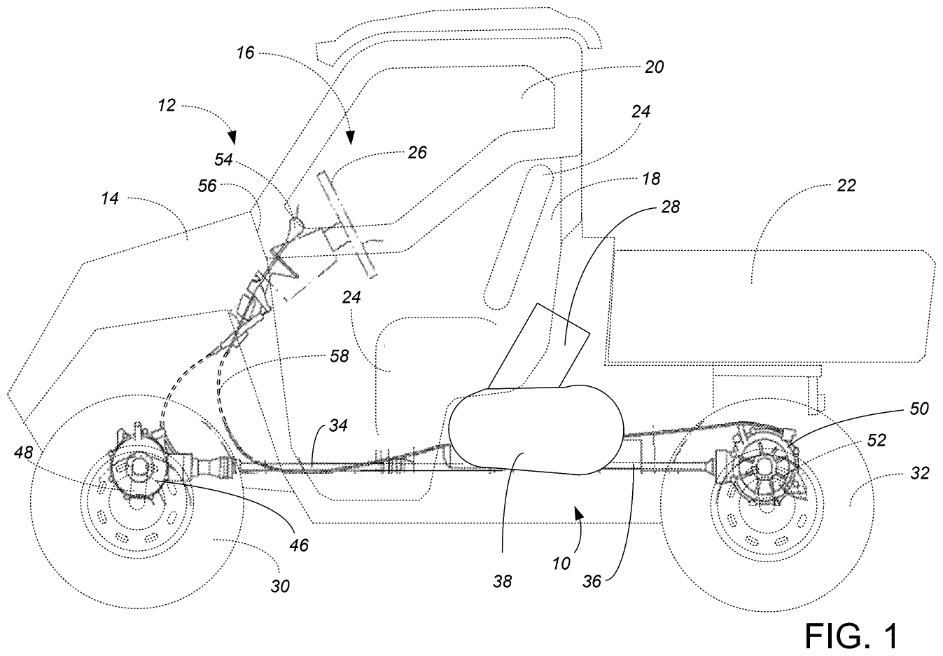

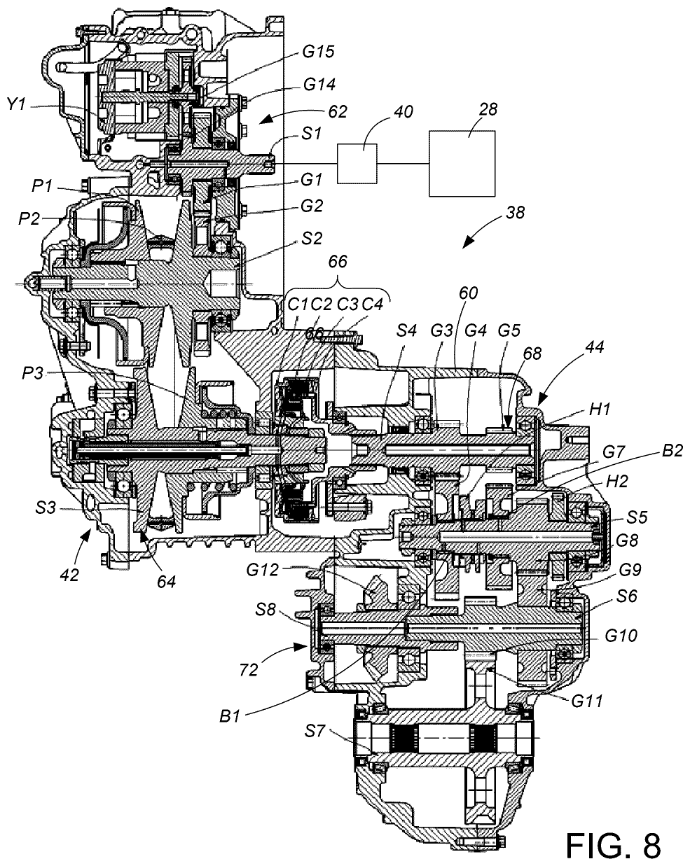

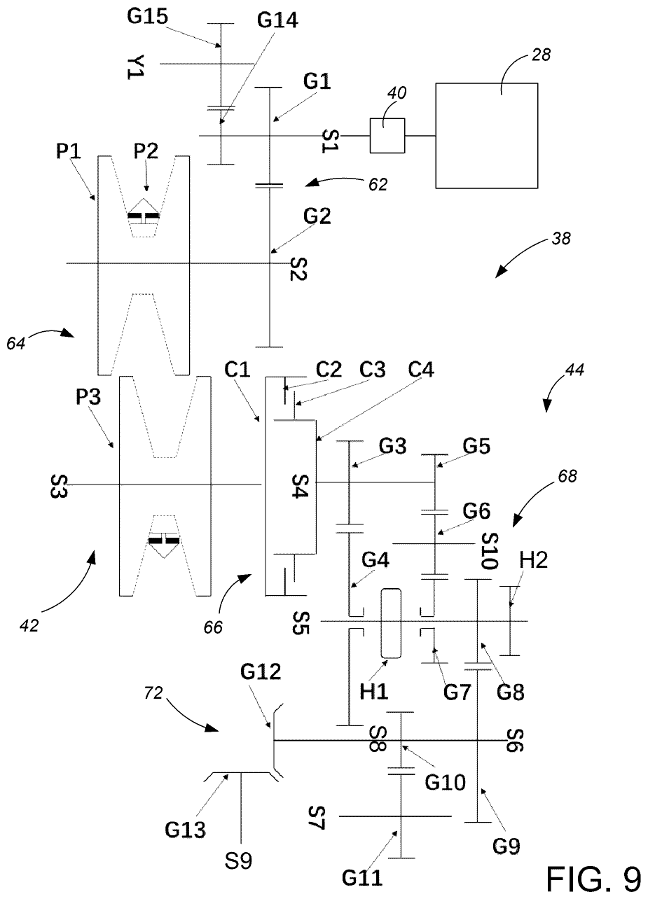

The transmission of the present invention is used in a power train 10 of a vehicle such as the off-road vehicle 12 shown schematically in FIG. 1. The vehicle 12 is depicted with a front hood 14, a passenger compartment or cab 16 with a door 18 and side window 20, and a rear cargo space 22. The driver (not shown) sits on a seat 24 and drives using a steering wheel 26. The vehicle 12 has a mid-mounted engine 28 which drives the front wheels and tires 30, the rear wheels and tires 32, or both the front and rear wheels, 30, 32 using a front drive shaft 34 and a rear drive shaft 36. The preferred power train 10 is driven by an internal combustion engine 28 (typically with one or two cylinders, although additional cylinders are possible) using a transmission 38, and the transmission 38 is preferably connected to the engine 28 through a torsional vibration damper 40 (shown schematically in FIGS. 8 and 9). The transmission 38 includes a continuously variable transmission (“CVT”) 42 and a gearbox 44. The specific front-to-rear, up-to-down and left-to-right layout of the engine 28. CVT 42 and gear box 44 is insignificant and can be reoriented, mirrored or flipped for any drive train layout as desired by the vehicle designer. The front drive shaft 34 drives the front wheels 30 through a front differential 46 and two front half shafts 48. The rear drive shaft 36 drives the rear wheels 30 through a rear differential 50 and two rear half shafts 52. If desired, the front differential 46 and/or the rear differential can include a differential lock (not shown). In some embodiments depending upon the vehicle layout and particularly if the engine 28 is positioned further rearward in the vehicle, the rear drive shaft can be omitted with the gear box 44 directly coupled to the rear differential 50. The preferred gear box 44 is operational based on a control within the cab 16 of the vehicle 12, such as a gear selector 54 that allows selection by the operator between park (“P”), reverse (“R”), neutral (“N”), drive (“D”) and sport (“S”) gears. For instance, the gear selector 54 can be positioned on a dashboard 56 (as shown) or console of the vehicle 12, connected to the gearbox 44 by a shift cable 58, lever or other linkage.

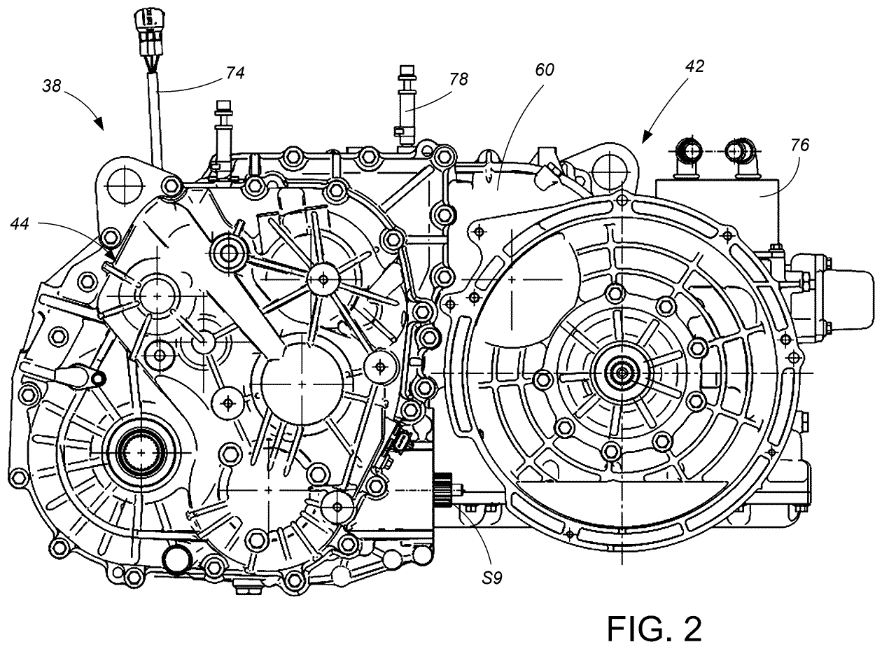

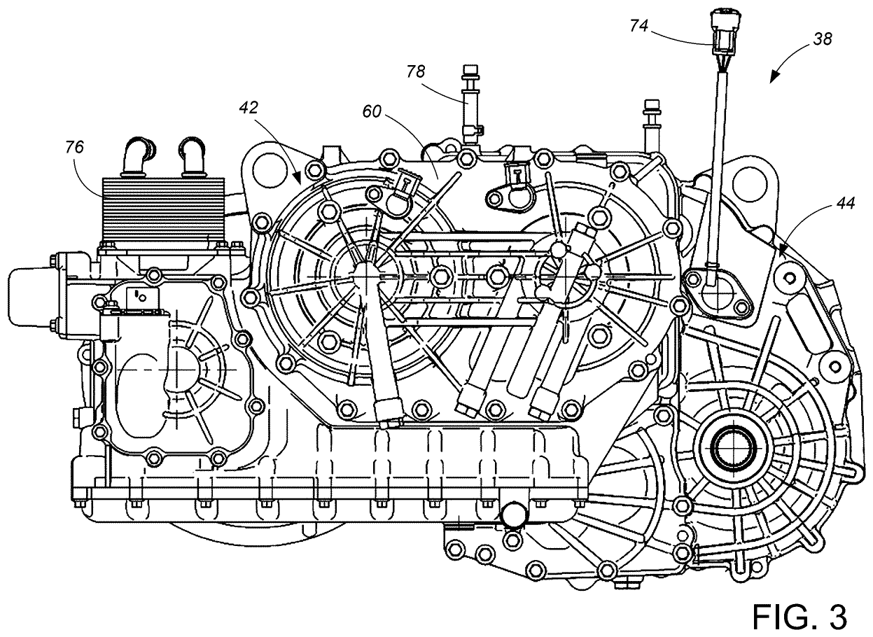

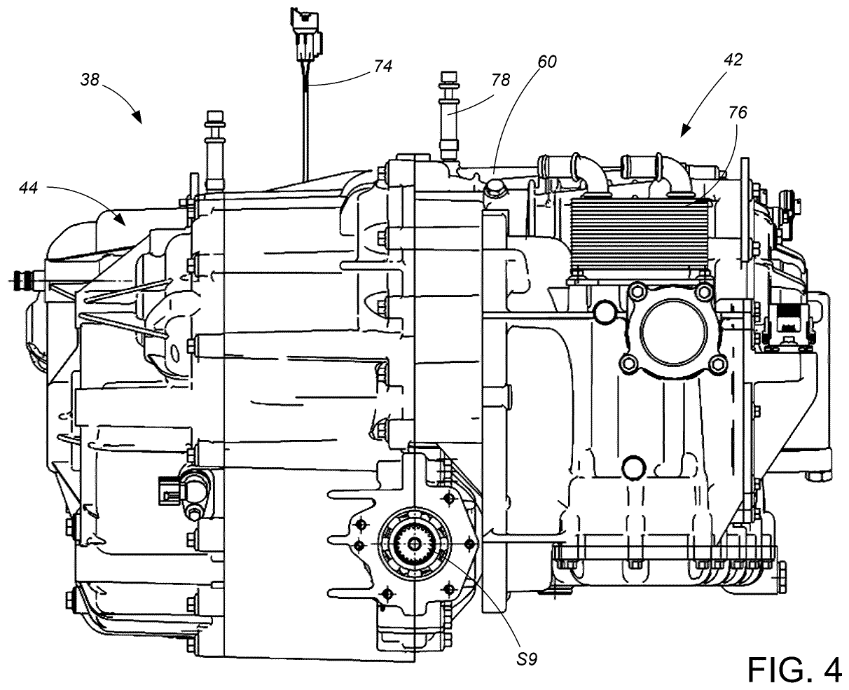

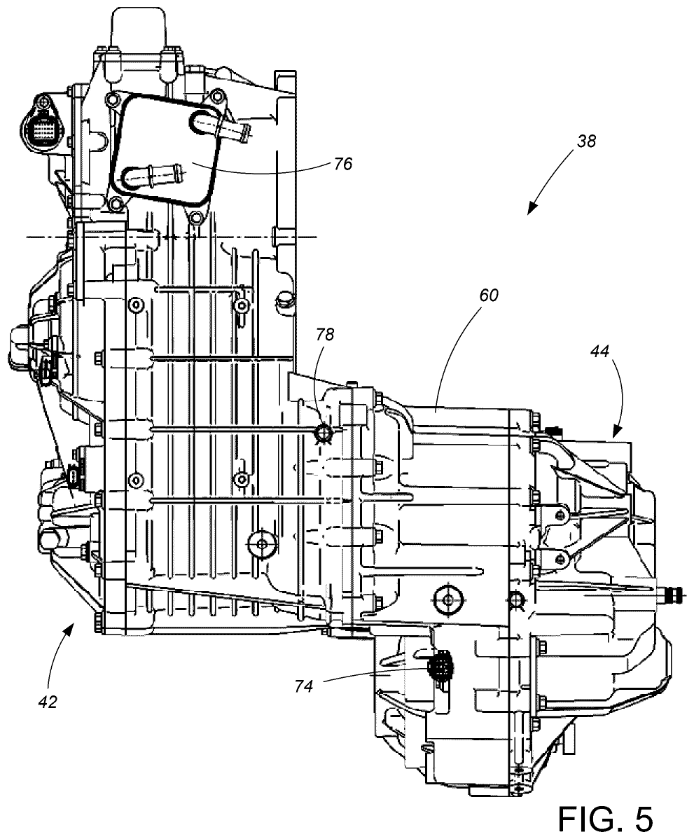

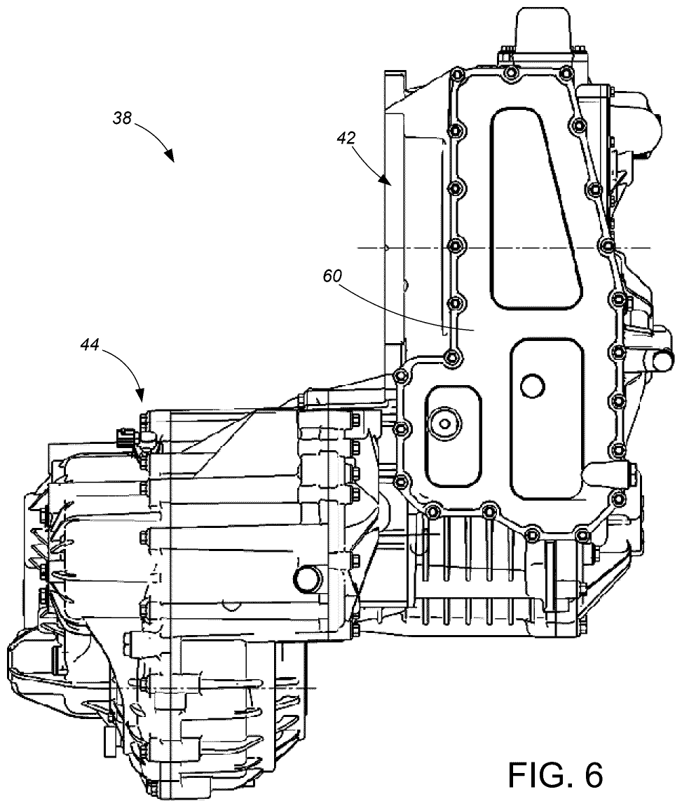

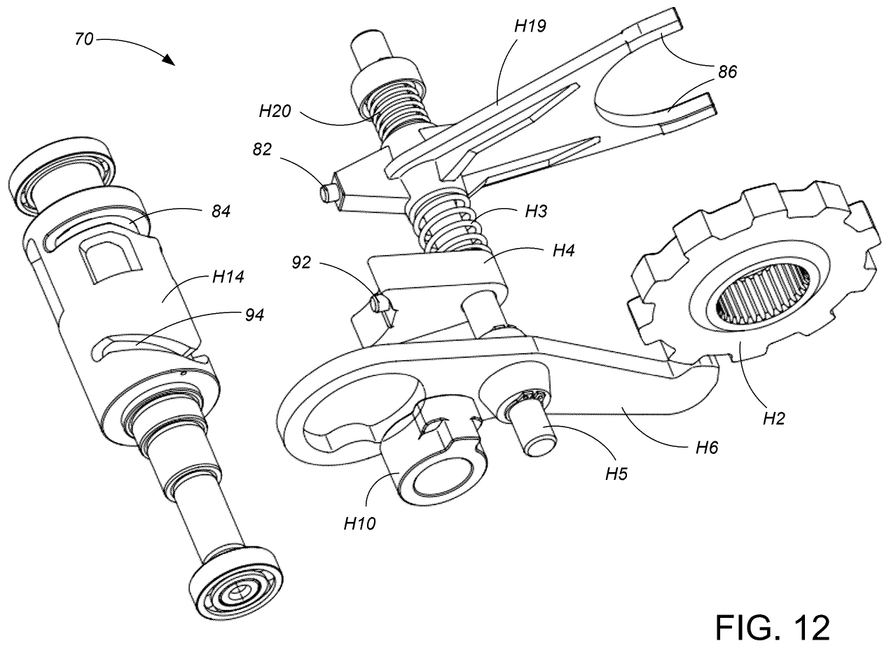

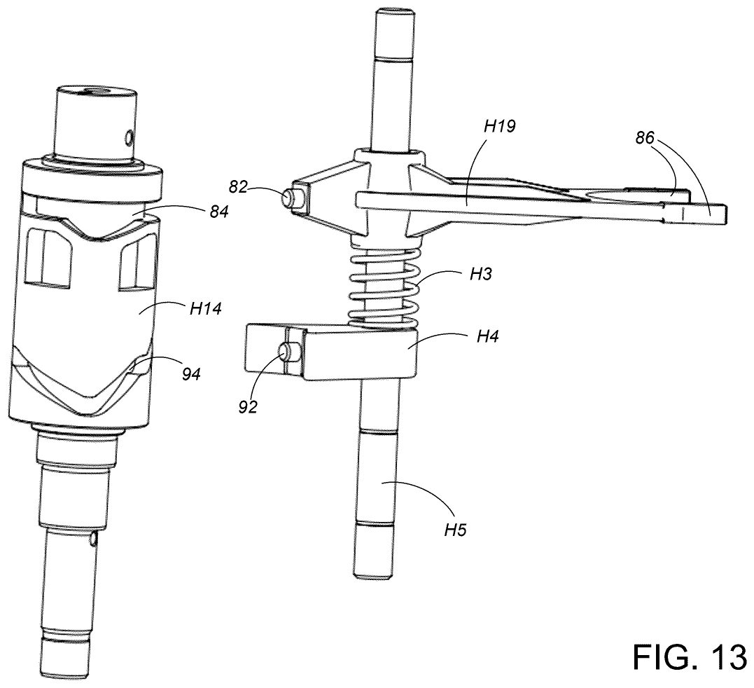

A transmission housing 60 for the CVT 42 and the gearbox 44 is better shown in FIGS. 2 to 5, and the internal components of the CVT 42 and gearbox 44 are better shown in FIGS. 6 to 13 wherein each individual internal component is identified by a reference having a letter and a numeral. The CVT 42 includes a power input stage 62 driving a pulley stage 64. The gearbox 44 includes a clutch 66, a forward and reverse gear assembly 68 controlled by a shift mechanism 70, and a power output stage 72 connected in sequence.

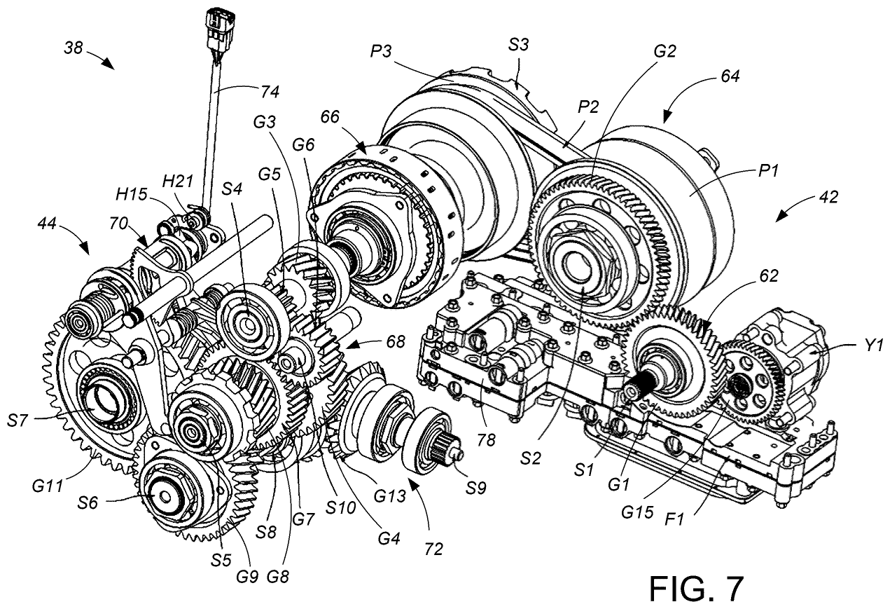

As best shown in FIGS. 7-9, the power input stage 62 includes a CVT input shaft S1, a input-stage driving gear G1, a input-stage driven gear G2, an oil pump driving gear G14, an oil pump driven gear G15, and an oil pump Y1. The CVT input shaft S1 is fixedly connected to the input-stage driving gear G1 for joint rotation, and the input-stage driving gear G1 is meshingly engaged with the input-stage driven gear G2. The CVT input shaft S1 is fixedly connected to a driven disc (not separately shown) of the torsional vibration damper 40 for joint rotation, and the torsional vibration damper 40 is coupled to the engine 28. The input-stage driven gear G2 is fixedly connected to the primary pulley shaft S2 of the CVT 42 for joint rotation. The oil pump driving gear G14 and the CVT input shaft S1 are preferably integrally formed. The oil pump driven gear G15 is coupled to the oil pump Y1. The oil pump driving gear G14 is meshingly engaged with the oil pump driven gear G15, such that the oil pump Y1 takes power from the CVT input shaft S1 through gear transmission. The oil pump Y1 is connected to a hydraulic valve block F1. The hydraulic valve block F1 is connected to an electronic control system 74 (only a portion of which is shown) for variable speed software control, and is further connected to an oil cylinder 76 (shown in FIGS. 2-5) and a oil circuit 78 (different portions of which are shown in FIGS. 2-5 and FIG. 7). Cooling and lubrication flow are thus also provided.

The relative number of teeth on the input-stage driving gear G1 and the input-stage driven gear G2 provides a gear reduction. The power input stage 62 places this gear reduction in front of/before the pulley stage 64 of the CVT 42, which reduces the rotational speed of the pulley stage 64.

The pulley stage 64 of the CVT 42 includes the primary pulley shaft S2, a primary pulley assembly P1, a belt or chain P2, a secondary pulley assembly P3, and a secondary pulley shaft S3. The primary pulley shaft S2 is fixedly connected to the input-stage driven gear G2 of the power input stage 62 for joint rotation. The primary pulley shaft S2 is connected to the primary pulley assembly P1. The primary pulley assembly P1 and the secondary pulley assembly P3 are coupled to each other by the belt/chain P2, with the primary pulley assembly P1 and the secondary pulley assembly P3 being pressed against the belt/chain through pulley cone surfaces. The rotational axes of the primary and secondary pulley shafts S2, S3 are parallel to the oil pump Y1 and the rotational axis of the oil pump driven gear G15, so the axial dimension of the CVT 42 can be more compact. The belt or chain P2 is preferably metal. Using a metal belt/chain P2 provides larger torque transmission, higher transmission efficiency, and higher reliability. The secondary pulley assembly P3 is connected to the secondary pulley shaft S3. The secondary pulley shaft S3 is connected to the clutch 66. The primary pulley assembly P1 and the secondary pulley assembly P3 are connected to the electro-hydraulic control system 74 which controls the effective diameters of the primary pulley assembly P1 and the secondary pulley assembly P3 where they contact the belt/chain P2. Using the electro-hydraulic control system 74, the speed ratio shifting logics are more diverse, and the speed ratio control accuracy is higher.

The clutch 66 is located at the rear end of/after the CVT 42. Positioning the clutch 66 at the output end of the CVT 42 is conducive to the overall layout of the off-road vehicle 12. As called out in FIGS. 8 and 9, the clutch 66 is preferably a wet start clutch which includes a clutch input disc C1, an outer friction plate C2, an inner friction plate C3, and a clutch output hub C4. The clutch input disc C1 is engaged with the outer friction plate C2 for joint rotation. The inner friction plate C3 is engaged with the clutch output hub C4 for joint rotation. The outer friction plate C2 and the inner friction plate C3 are in contact, transmitting torque when pressed against each other, but rotatably sliding/moving relative to each other when not transmitting torque. The clutch output hub C4 is fixedly connected to a driven gear shaft S4 of the forward and reverse gear assembly 68 for joint rotation. Using wet friction plates for the outer friction plate C2 and the inner friction plate C3 helps ensure smooth starting.

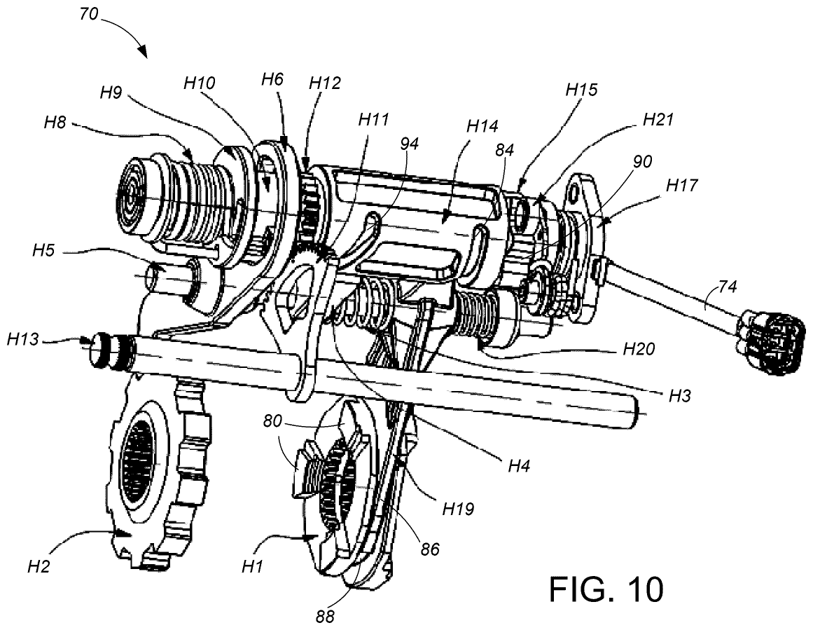

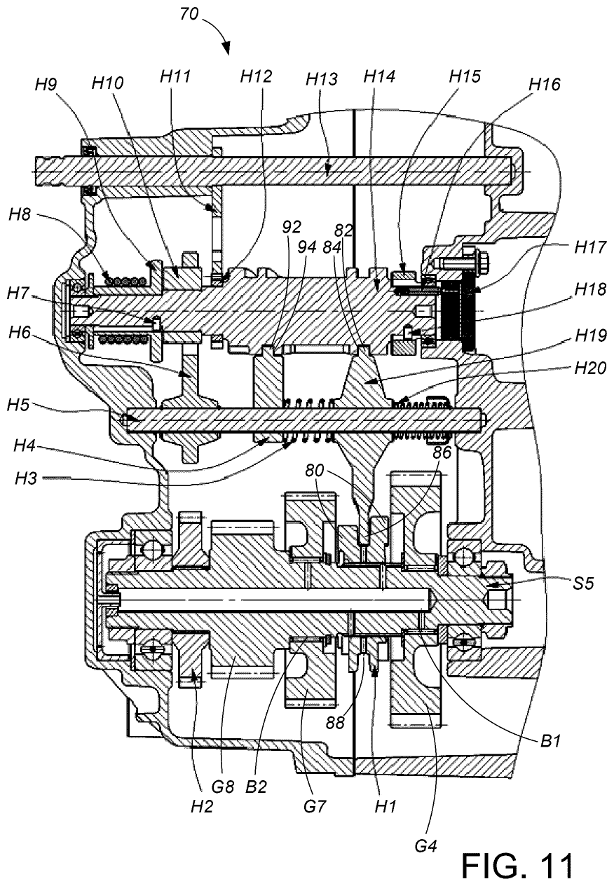

The forward and reverse gear assembly 68 includes the driven gear shaft S4, an auxiliary shaft S5, a reverse shaft S10, a forward driving gear G3, a forward driven gear G4, a reverse driving gear G5, a reverse bridge gear G6, a reverse driven gear G7, and an auxiliary shaft output gear G8. The forward driving gear G3, the reverse driving gear G5, and the driven gear shaft S4 are integrally formed or otherwise fixedly attached for joint rotation. The forward driven gear G4 and the reverse driven gear G7 are sleeved loosely on the auxiliary shaft S5 through needle bearings B1, B2. A shifting driving gear sleeve H1 is spline-coupled to the auxiliary shaft S5, positioned between the forward driven gear G4 and the reverse driven gear G7. A side of each of the forward driven gear G4 and the reverse driven gear G7 adjacent to the shifting driving gear sleeve H1 are provided with a series of recesses corresponding to side teeth 80 (best shown in FIGS. 10 and 11) in the shifting driving gear sleeve H1 for possible side-by-side meshed engagement depending upon the axial position of the shifting driving gear sleeve H1 on the auxiliary shaft S5. The auxiliary shaft output gear G8 and the auxiliary shaft S5 are integrally formed or otherwise fixedly attached for joint rotation. The forward driving gear G3 is meshingly engaged with the forward driven gear G4. The reverse bridge gear G6 is sleeved loosely on the reverse shaft S10 through a needle bearing (not shown). The reverse driving gear G5 is meshingly engaged with the reverse bridge gear G6. The reverse bridge gear G6 is meshingly engaged with the reverse driven gear G7. The auxiliary shaft output gear G8 is meshingly engaged with an intermediate gear G9 of the power output stage 72. The driven gear shaft S4 is fixedly connected to the clutch output hub C4 of the clutch 66 for joint rotation.

As best shown in FIGS. 10 and 11, the shift mechanism 70 includes the shifting driving gear sleeve H1, a parking gear H2, a compression-spring-with-two-moving-ends H3, a spring bias plate seat H4, a fork rod H5, a brake pawl H6, a parking drive sleeve positioning pin H7 (shown only in FIG. 11), a parking torsion spring H8, a parking drive sleeve H9, a parking cam H10, a fan-shaped toothed gear H11, a shifting driven gear H12, a shifting lever H13, a shifting drum H14, a positioning star-shaped wheel H15, a spherical contact H16 (shown only in FIG. 11), a gear position sensor H17, a star-shaped wheel positioning pin H18 (shown only in FIG. 11), a shifting fork H19, a compression-spring-with-one-fixed-end H20, and a retainer plate H21.

The shifting fork H19 is driven by the shifting drum H14 substantially as taught in U.S. Pat. No. 11,287,036, incorporated by reference. Specifically, the shifting fork H19 is sleeved loosely for axial movement on the fork rod H5. The shifting fork H19 has a positioning pin 82 riding in a concave shifting track 84 on the shifting drum H14. The opposite end of the shifting fork H19 has tines 86 riding in a peripheral groove 88 of the shifting driving gear sleeve H1. When the shifting drum H14 rotates, the positioning pin 82 causes the shifting fork H19 to move axially matching the shape of the shifting track 84. Rotation of the shifting drum H14 can be by electronic control or by manual control through the gear selector 54 (shown in FIG. 1) and shifting lever H13 allowing for diverse implementation methods.

The shifting driving gear sleeve H1 is spline-coupled to the auxiliary shaft S5 for joint rotation with the auxiliary shaft S5. The shifting driving gear sleeve H1 can move axially along the auxiliary shaft S5 and can occupy any of three stations, including a front (forward) station, a middle (neutral) station, and a rear (reverse) station. When the shifting driving gear sleeve H1 is moved by the shifting fork H19 to the front (forward) station, the side teeth 80 of the shifting driving gear sleeve H1 are side-by-side meshed in the recesses at the side of the forward driven gear G4. When the shifting driving gear sleeve H1 is moved by the shifting fork H19 to the rear (reverse) station, the side teeth 80 of the shifting driving gear sleeve H1 are side-by-side meshed in the recesses at the side of the reverse driven gear G7. When the shifting driving gear sleeve H1 is moved by the shifting fork H19 to the middle (neutral) station, the shifting driving gear sleeve H1 is engaged with neither the forward driven gear G4 nor the reverse driven gear G7, but is positioned at a mid location between the forward driven gear G4 and the reverse driven gear G7 contacting neither the forward driven gear G4 nor the reverse driven gear G7.

The proximal end of the fan-shaped toothed gear H11 is fixedly connected to the shifting lever H13 for joint pivoting about the axis of the shifting lever H13. The fan-shaped toothed gear H11 is meshingly engaged at its distal end with the shifting driven gear H12. The shifting driven gear H12 is fixedly connected to the shifting drum H14 for joint rotation. The shifting lever H13 has five rotation angle stations, and can be manually or electronically controlled to pivot/rotate, thereby driving the shifting drum H14 to rotate to a selected one of five angle stations. The shifting lever H13 is directly (preferably electronically) controlled to rotate the shifting drum H14 to a selected one of the five angle stations.

The positioning star-shaped wheel H15 and the shifting drum H14 are connected to each other by the star-shaped wheel positioning pin H18. The positioning star-shaped wheel H15 has five indentations 90, which correspond to the park gear P, the reverse gear R, the neutral gear N, the forward gear D, and the forward gear in the sport mode S, respectively. The five indentations 90 also correspond to the five angle stations, respectively. When the positioning star-shaped wheel H15 rotates, the five indentations 90 of the positioning star-shaped wheel H15 are sequentially engaged with the retainer plate H21. The retainer plate H21 is connected to the transmission housing 58.

Like the shifting fork H19, the spring bias plate seat H4 and the compression springs H3, H20 are all sleeved loosely for axial movement on the fork rod H5. The spring bias plate seat H4 has a positioning pin 92 riding in a concave biasing track 94 on the shifting drum H14. When the shifting drum H14 rotates, the positioning pin 92 causes the spring bias plate seat H4 to move axially matching the shape of the biasing track 94. One side of the spring bias plate seat H4 contacts the compression-spring-with-two-moving-ends H3. The compression-spring-with-one-fixed-end H20 and the compression-spring-with-two-moving-ends H3 press against two opposing sides of the shifting fork H19, respectively. The axial movement of the spring bias plate seat H4 allows precise control over the amount of compressive force provided by the compression-spring-with-two-moving-ends H3 against the shifting fork H19 as a function of angular position of the shifting drum H14, allowing for more accurate embedding of the side teeth 80 of the shifting fork H19 into the forward driven gear G4 or the reverse driven gear G7, making for smoother shifting into the forward gear D and into the reverse gear R.

The parking gear H2 is spline-coupled to the auxiliary shaft S5. The parking drive sleeve H9 and the shifting drum H14 are connected to each other by the parking drive sleeve positioning pin H7. The parking cam H10 is sleeved loosely on the shifting drum H14. The parking torsion spring H8 is connected to the parking drive sleeve H9 and also connected to the parking cam H10, thereby driving the parking cam H10 to rotate sequentially through the parking drive sleeve H9 and the parking torsion spring H8. The brake pawl H6 is sleeved loosely on the fork rod H5 and the parking cam H10. When the brake pawl H6 is resisted against a protrusion of the parking cam H10, the parking state is entered, and the brake pawl H6 is driven to engage with the parking gear H2. One end of the parking torsion spring H8 is fixed to the parking drive sleeve H9, and another end of the parking torsion spring H8 extends through a limiting hole of the parking drive sleeve H9, such that the brake pawl H6 and the parking gear H2 are engaged with each other without jamming. This allows the shifting of the park gear P to be smoother.

The spherical contact H16 is connected to the shifting drum H14 and in contact with the gear position sensor H17. The gear position sensor H17 is electrically connected to the vehicle system 74 and used to detect the position of the shifting drum H14, thereby facilitating accurate monitoring of the gear position.

As called out completely only in FIG. 9, the power output stage 72 includes an intermediate shaft S6, a rear driven shaft S7, a front driving shaft S8, a front driven shaft S9, an intermediate gear G9, a rear driving gear G10, a rear driven gear G11, a front driving gear G12, and a front driven gear G13. The intermediate gear G9 and the rear driving gear G10 are both fixedly connected (preferably integrally formed) to the intermediate shaft S6, the intermediate shaft S6 is fixedly connected to the front driving shaft S8 (more specifically, the front driving shaft S8 and the intermediate shaft S6 are spline-coupled to each other for common rotation), the front driving gear G12 is fixedly connected (preferably integrally formed) to the front driving shaft S8, the front driven gear G13 is fixedly connected (preferably integrally formed) to the front driven shaft S9, and the rear driven gear G11 is fixedly connected (preferably integrally formed) to the rear driven shaft S7. The front driven shaft S9 is coupled to the front drive shaft 34 (shown in FIG. 1), and the rear driven shaft S7 is coupled to the rear drive shaft 36 (shown in FIG. 1). The front driving gear G12 is meshingly engaged with the front driven gear G13. The rear driving gear G10 is meshingly engaged with the rear driven gear G11. In some embodiments with the CVT 42 and gearbox 44 mounted further rearward than shown in FIG. 1, the rear driven shaft S7 is integral to the rear differential 50.

The operation method of the continuously variable automatic transmission 38 for the off-road vehicle 12 is as follows:

(I) Operation of the power input stage 62: Torque of the engine 28 is output to the CVT 42 through the torsion vibration damper 40 by having the driven plate of the torsion vibration damper 40 connected to the CVT input shaft S1 such that torque is transmitted to the input-stage driving gear G1. Torque is transmitted to the primary pulley assembly P1 through the reduction transmission of the input-stage gears G1 and G2 and the primary pulley shaft S2.

(II) Continuous change of the speed ratio realized by the CVT 42: the electro-hydraulic control system 74 controls oil cylinder pressure in the primary pulley assembly P1 and the secondary pulley assembly P3, respectively, such that the primary pulley assembly P1 and the secondary pulley assembly P3 have controllable working radii. The belt/chain P2 transmits torque from the primary pulley assembly P1 to the secondary pulley assembly P3 and its secondary pulley shaft S3, thereby achieving continuously variable transmission.

(III) Further torque transmission and shifting among forward, neutral and reverse is realized by the forward and reverse gear assembly 68 and the shift mechanism 70: Torque is output from the secondary pulley shaft S3 to the driven gear shaft S4 through the clutch hub C1, the outer friction plate C2, the inner friction plate C3, and the clutch output disc C4. The shifting drum H14 is controlled to rotate by a certain angle, thereby driving the positioning star-shaped wheel H15 to rotate by the same angle. The five indentations 82 in the positioning star-shaped wheel H15 correspond to park gear P, reverse gear R, neutral gear N, forward gear D, and forward gear in sport mode S, respectively.

When the indentation 82 of the positioning star-shaped wheel H15 corresponding to the park gear P becomes engaged with the retainer plate H21, during the rotation of the shifting drum H14, the parking cam H10 is driven to rotate through the parking drive sleeve H9 and the parking torsion spring H8 until the protrusion of the parking cam H10 is against the brake pawl H6, driving the brake pawl H6 to engage with the parking gear H2, and the parking gear H2 stops the rotation of the auxiliary shaft S5, thereby achieving park P.

When rotation of the shifting drum H14 causes the indentation 82 of the positioning star-shaped wheel H15 corresponding to the reverse gear R to become engaged with the retainer plate H21, the shifting fork H19 moves along the shifting track 84 causing the shifting driving gear sleeve H1 connected to the shifting fork H19 to move axially into side-by-side meshed engagement with the reverse driven gear G7. Axial movement of the shifting driving gear sleeve H1 changes the length occupied by the compression-spring-with-one-fixed-end H20 and therefore changes the sideways force provided by the compression-spring-with-one-fixed-end H20 on the shifting driving gear sleeve H1. Axial movement of the shifting driving gear sleeve H1 also changes the location on one end of the compression-spring-with-two-moving-ends H3. At the same time due to the rotation of the shifting drum H14, the spring bias plate seat H4 is moved axially due to the shape of the biasing track 94. Axial movement of the spring bias plate seat H4 changes the location of the other end of the compression-spring-with-two-moving-ends H3. The deformation amount of the compression-spring-with-two-moving-ends H3 is thereby controlled by the shape of the biasing track 94 relative to the shape of the shifting track 84. The force of the compression-spring-with-two-moving-ends H3 can be precisely controlled by appropriately designing the relative shapes of both tracks 84, 94. The aggregate sideways force on the shifting fork H19 and the shifting driving gear sleeve H1—i.e., the forces provided by the two springs H20, H3 together with the sideways force provided by the shifting fork positioning pin 82 riding in the shafting track 84—is exactly as desired as a function of the angle position of the shift drum H14 for smooth and accurate movement of the shifting driving gear sleeve H1 into side-by-side meshed engagement with the reverse driven gear G7. Once in meshed engagement in reverse gear R, torque is sequentially delivered through the driven gear shaft S4, the reverse driving gear G5, the reverse bridge gear G6, the reverse driven gear G7, and the shifting driving gear sleeve H1, and drives the auxiliary shaft S5 to rotate in a reverse direction. Then, torque is further sequentially delivered through the auxiliary shaft output gear G8 and the intermediate gear G9 and drives the intermediate shaft S6 to rotate in the reverse direction. The intermediate shaft S6 drives the front driven shaft S9, and drives the rear driven shaft S7 through the rear driving gear G10 and the rear driven gear G11, which in turn drive the front drive shaft 34 and the rear drive shaft 36 (both shown in FIG. 1) causing rotation of the front wheels 30 and the rear wheels 32, thereby achieving reverse torque in four-wheel drive.

When rotation of the shifting drum H14 causes the indentation 82 of the positioning star-shaped wheel H15 corresponding to the neutral gear N to become engaged with the retainer plate H21, the shifting fork H19 moves along the shifting track 84 causing the shifting driving gear sleeve H1 connected to the shifting fork H19 to move axially out of side-by-side meshed engagement with the reverse driven gear G7 and into the middle station. Axial movement of the shifting driving gear sleeve H1 again changes the end point locations of the contacting end of both the compression-spring-with-one-fixed-end H20 and the compression-spring-with-two-moving-ends H3. At the same time during rotation of the shifting drum H14, the spring bias plate seat H4 is moved axially due to the shape of the biasing track 94, changing the location of the other end of the compression-spring-with-two-moving-ends H3. The aggregate sideways force provided by both the compression-spring-with-one-fixed-end H20 and the compression-spring-with-two-moving-ends H3 on the shifting driving gear sleeve H1 can be carefully controlled as a function of the angular rotation of the shifting drum H14 while pushing the shifting driving gear sleeve H1 out of meshing engagement with the reverse driven gear G7.

When rotation of the shifting drum H14 causes the indentation 82 of the positioning star-shaped wheel H15 corresponding to the forward gear D to become engaged with the retainer plate H21, the shifting fork H19 moves further along the shifting track 84 causing the shifting driving gear sleeve H1 connected to the shifting fork H19 to move axially out of the middle (neutral) station and into the front (forward) station in side-by-side meshed engagement with the forward driven gear G4. Simultaneous with the axial movement of the shifting fork H19, the biasing track 94 moves the spring bias plate seat H4 axially, increasing the force of the compression-spring-with-two-moving-ends H3, such that the force that the compression-spring-with-two-moving-ends H3 applied onto the shifting fork H19 is greater than the force of the compression-spring-with-one-fixed-end H20. Thus, the shifting fork H19 can be more accurately embedded into the forward driven gear G4. Torque is sequentially delivered through the driven gear shaft S4, the forward driving gear G3, the forward driven gear G4, and the shifting driving gear sleeve H1, driving the auxiliary shaft S5 to rotate in the forward direction. Then, torque is sequentially delivered through the auxiliary shaft output gear G8 and the intermediate gear G9 and drives the intermediate shaft S6 to rotate in the forward direction. The intermediate shaft S6 drives the front driven shaft S9, and drives the rear driven shaft S7 through the rear driving gear G10 and the rear driven gear G11, which in turn drive the front drive shaft 34 and the rear drive shaft 36 (both shown in FIG. 1) causing rotation of the front wheels 30 and the rear wheels 32, thereby achieving forward torque in four-wheel drive.

When further rotation of the shifting drum H14 causes the groove of the positioning star-shaped wheel H15 corresponding to the forward gear in the sport mode S to become engaged with the retainer plate H21, the spring bias plate seat H4 and the shifting fork H19 have no further movement in the horizontal direction. The state of the spring bias plate seat H4 and the shifting fork H19 are the same in both the forward gear D and the sport mode S, but the power is greater.

The method for controlling the shifting drum H14 to rotate by a certain angle can be achieved by manually controlling the rotation of the shifting lever H13, such that the shifting drum H14 rotates by a certain angle through the fan-shaped toothed gear H11 and the shifting driven gear H12. Alternatively, the shifting drum H14 can also be electronically controlled to rotate by a certain angle.

The continuously variable automatic transmission 38 for the off-road vehicle 12 and the operation method discussed above have following beneficial effects:
(1) The force provided by the compression-spring-with-two-moving-ends H3 can be carefully controlled by the relative spacing between the two tracks 84, 94. The shifting fork H19 can more accurately insert the shifting driving gear sleeve H1 into the forward driven gear G4 or the reverse driven gear G7, thereby allowing the shifting of the reverse gear R and the forward gear D to be smoother.
(2) The shifting drum H14 rotates and cooperates with the shifting fork H19 to shift among forward gear D, neutral gear N, and reverse gear R. The shifting drum H14 rotates and cooperates with the parking cam H6 to achieve park gear P.
(3) The present invention not only realizes the shifting among the park gear P, the reverse gear R, the neutral gear N, and the forward gear D, but also reserves a forward gear in the sport mode S that has stronger forward power.
(4) The intermediate shaft S6 distributes torque to the front wheels 30 and the rear wheels 32, thereby realizing four-wheel drive. The continuously variable automatic transmission 38 has high transmission efficiency, large torque transmission, and high reliability, which can meet the requirements of the off-road vehicle 12.
(5) The design of the parking torsion spring H8 and parking cam H10 allows the brake pawl H6 and the parking gear H2 to be engaged with each other without jamming, resulting in smoother shifting into the park gear P.
(6) The continuously variable automatic transmission 38 utilizes a wet start clutch for clutch 66. Only one clutch hub C1 is included, and the number of the clutch plates C2, C3 is fewer, such that the control method for the clutch 66 is simpler and the transmission efficiency is higher. The clutch 66 is located at the rear (output) end of the CVT 42, which is conducive to the overall layout of the off-road vehicle 12.
(7) Use of the gear position sensor H17 facilitates accurate monitoring of the rotation angle of the shift drum H14 for more reliable gear positioning.
(8) The parallel layout of the oil pump Y1 and the pulley shafts S2, S3 leads to a more compact arrangement. When pressure is built in the hydraulic system, oil pressure can be provided for pulleys P1, P2 of the CVT 42 and the start clutch 66. Cooling and lubrication flow are also provided.
(9) Furthermore, the oil circuit of the forward and reverse gear assembly 68 and the oil circuit of the shift mechanism 70 can be made simpler. Compared to the existing passive speed control, the pressing force and the speed ratio can be precisely and more simply controlled through the electro-hydraulic system 74, which can achieve diverse gear shifting logics and higher speed ratio control accuracy.
(10) The three-stage gear reduction transmission is also arranged after the clutch 66. The intermediate shaft S6 distributes torque to the rear driven shaft S7 which transfers power to the rear wheels 32 thereby achieving rear wheel drive, and to the front driven shaft S9 which transfers power to the front wheels 30 achieving front wheel drive.

It is to be understood, even though information and advantages of the present embodiments have been set forth in the foregoing description, together with details of the structures and functions of the present embodiments, the disclosure is illustrative only, changes may be made in detail, especially in matters of shape, size, and arrangement of parts within the principles of the present embodiments to the full extent indicated by the plain meaning of the terms in which the appended claims are expressed.

1. A continuously variable automatic transmission for an off-road vehicle, comprising:
a power input stage adapted for connection to an engine;
a pulley stage driven by the power input stage, the pulley stage having a primary pulley assembly and a secondary pulley assembly, with a belt or chain transferring torque from the primary pulley assembly to the secondary pulley assembly, wherein effective diameters of the primary pulley assembly and the secondary pulley assembly where they contact the belt or chain are variable;
a clutch which can transmit torque output by the pulley stage;
a forward and reverse gear assembly coupled to the clutch;
a shift mechanism connected to the forward and reverse gear assembly, the shift mechanism comprising:
a shift drum having a shifting track and a biasing track, the shift drum being rotatable between at least positions for a reverse gear R, a neutral gear N, and a forward gear D;
a shift fork controlled by the shifting track;
a shifting driving gear sleeve coupled to the shift fork, the shifting driving gear sleeve being able to carry torque in the forward and reverse gear assembly, the shape of the shifting track controlling the shift fork to move the shifting driving gear sleeve axially between a reverse gear station, a forward gear station and a neutral gear station between the reverse gear station and the forward gear station;
a spring bias plate seat controlled by the biasing track; and
a spring-with-two-moving-ends biasing the shift fork relative to the spring bias plate seat, such that an aggregate sideways force on the shift fork in an axial direction can be controlled at least in part by relative spacing between the shifting track and the biasing track as a function of rotation of the shift drum; and
an output stage coupled to the forward and reverse gear assembly and receiving torque transmitted through the shifting driving gear sleeve, the output stage having a front output for providing torque to a pair of front wheels and a rear output for providing torque to a pair of rear wheels.

2. The continuously variable automatic transmission of claim 1, wherein the power input stage comprises an input-stage driving gear meshingly engaged with an input-stage driven gear, and wherein a relative number of teeth on the input-stage driving gear and the input-stage driven gear provides a gear reduction.

3. The continuously variable automatic transmission of claim 2, wherein the engine transmits torque to the power input stage through a torsional vibration damper.

4. The continuously variable automatic transmission of claim 2, wherein the power input stage further comprises an oil pump driving gear meshingly engaged with an oil pump driven gear, and an oil pump powered by the oil pump driven gear, wherein the oil pump driven gear rotates about an axis which is parallel to rotational axes of the primary pulley assembly and secondary pulley assembly.

5. The continuously variable automatic transmission of claim 1, wherein the belt or chain is formed of metal.

6. The continuously variable automatic transmission of claim 1, wherein the shift mechanism further comprises a positioning star-shaped wheel which is rotatable with the shift drum, the positioning star-shaped wheel having five indentations, the five indentations sequentially corresponding to a park gear P, the reverse gear R, the neutral gear N, the forward gear D, and a forward gear in a sport mode S.

7. The continuously variable automatic transmission of claim 6, wherein the shift mechanism further comprises a fork rod and a spring-with-one-fixed-end, with the spring-with-two-moving-ends, the shift fork and the spring-with-one-fixed-end all slidably mounted on the fork rod, and with the spring-with-two-moving-ends and the spring-with-one-fixed-end biasing opposing sides of the shift fork.

8. The continuously variable automatic transmission of claim 1, wherein the shift mechanism further comprises a positioning star-shaped wheel which is rotatable with the shift drum, the positioning star-shaped wheel having five indentations, the five indentations sequentially corresponding to a parking gear P.

9. The continuously variable automatic transmission of claim 8, wherein the shift mechanism further comprises a brake pawl mounted on the fork rod and a parking gear, the brake pawl engaging with the parking gear when in the park gear P such that the parking gear prevents rotation of the shifting driving gear sleeve when in the park gear P.

10. The continuously variable automatic transmission of claim 9, wherein the shift mechanism further comprises a parking torsion spring which can bias the brake pawl into engagement with the parking gear.

11. The continuously variable automatic transmission of claim 9, wherein the parking gear and the shifting driving gear sleeve are both spline coupled on an auxiliary shaft, and wherein the forward and reverse gear assembly comprises a forward driven gear and a reverse driven gear both mounted on the auxiliary shaft with needle bearings.

12. The continuously variable automatic transmission of claim 1, wherein the clutch comprises a clutch input disc engaged with an outer friction plate for joint rotation, and an inner friction plate engaged with a clutch output hub for joint rotation, wherein the outer friction plate and the inner friction plate are in contact, transmitting torque when pressed against each other, but rotatably sliding/moving relative to each other when not transmitting torque.

13. The continuously variable automatic transmission of claim 1, wherein the shift mechanism further comprises a gear position sensor monitoring rotation angle of the shift drum.

14. A continuously variable automatic transmission for an off-road vehicle, comprising:
a pulley stage having a primary pulley assembly and a secondary pulley assembly, the primary pulley assembly being driven by torque from an engine of the off-road vehicle, with a belt or chain transferring torque from the primary pulley assembly to the secondary pulley assembly, wherein effective diameters of the primary pulley assembly and the secondary pulley assembly where they contact the belt or chain are variable;
a forward and reverse gear assembly which can receive torque from the secondary pulley assembly, the forward and reverse gear assembly comprising a forward driven gear and a reverse driven gear both bearing mounted on a shaft; and
a shift mechanism connected to the forward and reverse gear assembly, the shift mechanism comprising:
a shift drum having a shifting track and a biasing track, the shift drum being rotatable between at least positions for a reverse gear R, a neutral gear N, and a forward gear D;
a shift fork controlled by the shifting track;
a shifting driving gear sleeve coupled to the shift fork and spline-coupled on the shaft, the shifting driving gear sleeve being able to carry torque in the forward and reverse gear assembly, the shape of the shifting track controlling the shift fork to move the shifting driving gear sleeve axially between a reverse gear station wherein the shifting driving gear sleeve is in side-by-side engagement with the reverse driven gear, a forward gear station wherein the shifting driving gear sleeve is in side-by-side engagement with the forward driven gear and a neutral gear station located between the reverse gear station and the forward gear station wherein the shifting driving gear sleeve is in engagement with neither the reverse driven gear nor the forward driven gear;
a spring bias plate seat controlled by the biasing track; and
a spring-with-two-moving-ends biasing the shift fork relative to the spring bias plate seat, such that an aggregate sideways force on the shift fork in an axial direction can be controlled at least in part by relative spacing between the shifting track and the biasing track as a function of rotation of the shift drum.

15. The continuously variable automatic transmission of claim 14, wherein the engine delivers torque to the primary pulley assembly through a torsional vibration damper and a power input stage, wherein the power input stage comprises:
an input-stage driving gear receiving torque from the torsional vibration damper;
an input-stage driven gear meshingly engaged with the input-stage driving gear, wherein a relative number of teeth on the input-stage driving gear and the input-stage driven gear provides a gear reduction
an oil pump driving gear receiving torque from the torsional vibration damper;
an oil pump driven gear meshingly engaged with the oil pump driving gear, wherein the oil pump driven gear rotates about an axis which is parallel to rotational axes of the primary pulley assembly and secondary pulley assembly; and
an oil pump powered by the oil pump driven gear.

16. The continuously variable automatic transmission of claim 14, wherein the shift mechanism further comprises a fork rod and a spring-with-one-fixed-end, with the spring-with-two-moving-ends, the shift fork and the spring-with-one-fixed-end all slidably mounted on the fork rod, and with the spring-with-two-moving-ends and the spring-with-one-fixed-end biasing opposing sides of the shift fork.

17. The continuously variable automatic transmission of claim 16, wherein the shift mechanism further comprises a brake pawl mounted on the fork rod and a parking gear spline-coupled on the shaft, the brake pawl being engagable with the parking gear to prevent rotation of the shaft.

18. The continuously variable automatic transmission of claim 17, wherein the shift mechanism further comprises a parking torsion spring which can bias the brake pawl into engagement with the parking gear.

19. The continuously variable automatic transmission of claim 14, further comprising a clutch interposed between the pulley stage and the forward and reverse gear assembly, wherein the clutch comprises a clutch input disc engaged with an outer friction plate for joint rotation, and an inner friction plate engaged with a clutch output hub for joint rotation, wherein the outer friction plate and the inner friction plate are in contact, transmitting torque when pressed against each other, but rotatably sliding/moving relative to each other when not transmitting torque.

20. A continuously variable automatic transmission for an off-road vehicle, comprising:
a power input stage comprising:
an input-stage driving gear receiving torque from an engine of the off-road vehicle;
an input-stage driven gear meshingly engaged with the input-stage driving gear, wherein a relative number of teeth on the input-stage driving gear and the input-stage driven gear provides a gear reduction
an oil pump driving gear receiving torque from the torsional vibration damper;
an oil pump driven gear meshingly engaged with the oil pump driving gear, wherein the oil pump driven gear rotates about an axis which is parallel to rotational axes of the primary pulley assembly and secondary pulley assembly; and
an oil pump powered by the oil pump driven gear;
a pulley stage having a primary pulley assembly and a secondary pulley assembly, the primary pulley assembly being driven by torque from the input-stage driven gear of the power input stage, with a belt or chain transferring torque from the primary pulley assembly to the secondary pulley assembly, wherein effective diameters of the primary pulley assembly and the secondary pulley assembly where they contact the belt or chain are variable;
a clutch which can transmit torque output by the pulley stage;
a forward and reverse gear assembly which can receive torque from the clutch, the forward and reverse gear assembly comprising a forward driven gear and a reverse driven gear both bearing mounted on a shaft;
a shift mechanism connected to the forward and reverse gear assembly, the shift mechanism comprising a shifting driving gear sleeve spline-coupled on the shaft, the shifting driving gear sleeve being able to carry torque in the forward and reverse gear assembly, the shifting driving gear sleeve being axially movable between a reverse gear station wherein the shifting driving gear sleeve is in side-by-side engagement with the reverse driven gear, a forward gear station wherein the shifting driving gear sleeve is in side-by-side engagement with the forward driven gear and a neutral gear station located between the reverse gear station and the forward gear station wherein the shifting driving gear sleeve is in engagement with neither the reverse driven gear nor the forward driven gear; and
an output stage coupled to the forward and reverse gear assembly and receiving torque transmitted through the shifting driving gear sleeve, the output stage having a front output for providing torque to a pair of front wheels and a rear output for providing torque to a pair of rear wheels.
